(19) United States
(12) Patent Application Publication
(10) Pub. No.: US 2003/0137206 A1
(43) Pub. Date: Jul. 24, 2003

(54) Electric rotary machine

(76) Inventors: Dirk Peier, Dortmund (DE); Katrin Temmen, Dortmund (DE)

Correspondence Address: Baker & Daniels, Suite 800, 111 East Wayne Street, Fort Wayne, IN, 46802, US

(21) Appl. No.: 10/204,833

(22) PCT Filed: Feb. 10, 2001
(86) PCT No.: PCT/EP01/01472

(30) Foreign Application Priority Data
Feb. 25, 2000 (DE) 10008803.1

(51) Int. Cl. H02K 1/00; H02K 3/00

(52) U.S. Cl. 310/180

(57) ABSTRACT

The invention relates to an electric rotary machine (2), especially a high-voltage generator. The aim of the invention is to provide such a machine with a more efficient cooling and a good insulation. To this end, the high voltage conductors (14) are embedded in channels (12) via a special ceramic powder embedding material (20). Said embedding material (20) has a good thermoconductivity, excellent electrical insulation properties and contains especially aluminum oxide and aluminum nitride as the powder components.

The invention concerns an electric rotary machine, in particular a high-voltage generator, with a stator that has a main body and a stator coil with a number of high-voltage conductors running in the main body.

A conventional electric rotary machine, for instance a turbo-generator for use in the field of power generation, is designed for a relatively low voltage of 10-25 kV. However, the rotary machine, in particular the generator to which this invention refers, is designed for high voltage. In this case, high voltage is understood to range from 30 KV to several 100 KV. This type of high-voltage generator is specially designed for the power supply of long-distance networks, for example, for 110 KV. The main advantage of the high-voltage generator is that it can feed power directly into the long-distance network, without requiring a transformer.

An important difference between a conventional generator and a high-voltage generator consists in the design of its coils. In particular, this concerns the formation of the individual conductors, which, in the case of the high-voltage generator, are designed as high-voltage conductors. Based on the occurring very high voltages, the high-voltage conductors must have a fundamentally different insulation than the conductors of conventional generators. The high-voltage conductors are similar to conventional high-voltage cables and, as a rule, have a bundle of cable lanes, which are covered by an appropriate insulation, in particular a plastic insulation.

Based on the high voltages, high-voltage generators demand a new construction with regard to electric/mechanical boundary conditions as well as with regard to the generator cooling.

WO 97/45934 and WO 97/45914 each describe a high-voltage generator whose stator has a stator coil with a number of high-voltage conductors. The stator is made of individual tooth-like stator segments that each extend in the longitudinal direction of the generator and have a somewhat trapezoidal cross-section surface. The individual stator segments form a main body of the stator. In this main body, especially in each of the stator segments, a groove is incorporated, in each of which several of the high-voltage conductors are arranged. Like the high-voltage conductors, the groove also runs in the longitudinal direction of the generator and extends in the radial direction into the main body of the stator. The individual high-voltage conductors arranged in a groove form a row in the radial direction. Each individual groove has a complex geometry, whereby the sidewalls of the groove are formed by curvatures corresponding to the individual high-voltage conductors. In a cross-sectional view, the groove form is comparable with that of a bicycle chain.

For the cooling of the stator, in accordance with WO 97/45914, a number of cooling channels are provided that extend in the longitudinal direction through the main body and are arranged between the individual grooves. A cooling cable filled with a coolant is built into each of these cooling channels. In order to achieve good thermal contact with the main body, it is necessary to insert a filling material between each cooling cable and the assigned cooling channel. And, since there is a gap between the high-voltage conductors and the main body at least in some areas, the heat transport of the high-voltage conductors to the cooling channels is made more difficult.

WO 97/45934 concerns in part the insulation of the high-voltage conductors. Their insulating covering has, in particular, a special multi-layer construction for electric insulation. In order to strengthen the insulating effect, a special interior lining or coating is provided for the groove.

The purpose of the invention is to provide an electric rotary machine, in particular a high-voltage generator, which guarantees safe and reliable operation.

In accordance with the invention, this function is fulfilled by an electric rotary machine, in particular a high-voltage generator, with a stator, that has a main body and a stator coil with a number of high-voltage conductors running in the main body, whereby at least some of the high-voltage conductors in the main body are embedded by means of an embedding material.

This has the important advantage that there is no gap that works as a thermal insulator between the individual high-voltage conductors and the main body. With the help of the embedding material, good heat transport from the high-voltage conductors is thus achieved. This increases the effectiveness of a cooling system.

If several high-voltage conductors are installed together in one groove or in one channel in the main body, then the embedding material advantageously ensures that the position of the individual high-voltage conductors is fixed with respect to each other. Thus, in this case, it is not necessary to realize the position specification of the high-voltage conductors via a complex geometry of the groove.

In a preferred design, the embedding material has good thermoconductivity and/or good electric insulating properties. Good thermoconductivity ensures effective cooling, and the electric insulating properties prevent the occurrence of electrical strokes between the individual high-voltage conductors. The embedding material preferably fulfills both of these functions in combination, so that the advantages of high thermoconductivity, good electric insulation, and position specification of the high-voltage conductors are realized in a simple manner.

For ease of use, it is preferred that the embedding material be powdered in form. This ensures that the hollow spaces between the high-voltage conductors and the main body are completely filled with the embedding material.

The embedding material is preferably a ceramic powder with good thermoconductivity and/or with good electric insulating properties, since ceramic powder is particularly well suited with respect to electric insulating properties.

Aluminum oxide, which is both a good thermal conductor as well as a good electric insulator and is also reasonably priced, is preferably used as the ceramic powder. Aluminum nitride, boron nitride, magnesium oxide, or a combination of these powders are preferred as alternative powders. For example, a mixture of aluminum nitride and aluminum oxide is used as preferred ceramic powder.

Appropriately, several of the high-voltage conductors together with a channel running in the longitudinal direction through the main body are arranged next to each other in the radial direction, enabling a comparably simple construction of the stator.

Appropriately, the channel is thereby bordered by even sidewalls and has, in particular, a rectangular cross-sectional surface. For one, this is very easy to realize from a production-technique perspective and, on the other hand, the mainly smooth outer contour of the channel without curvatures and points has a positive effect on the magnetic and electrical fields occurring during generator operation.

A design example of the invention will be described below using the drawings. Each of the following is shown in very simplified figures:

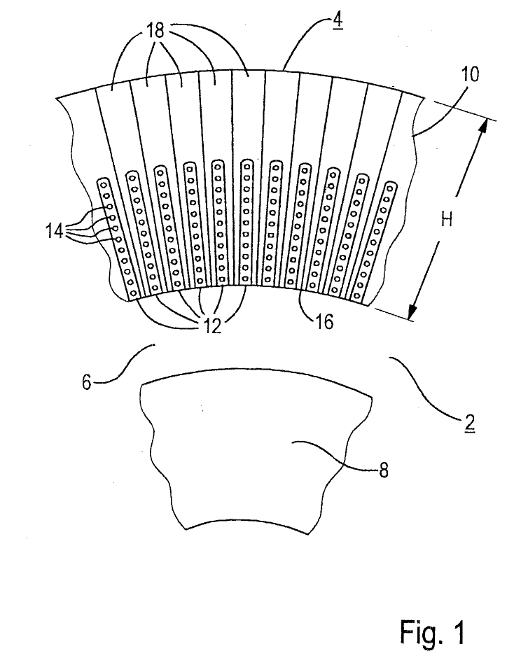

FIG. 1 a section from a cross-section through a generator,

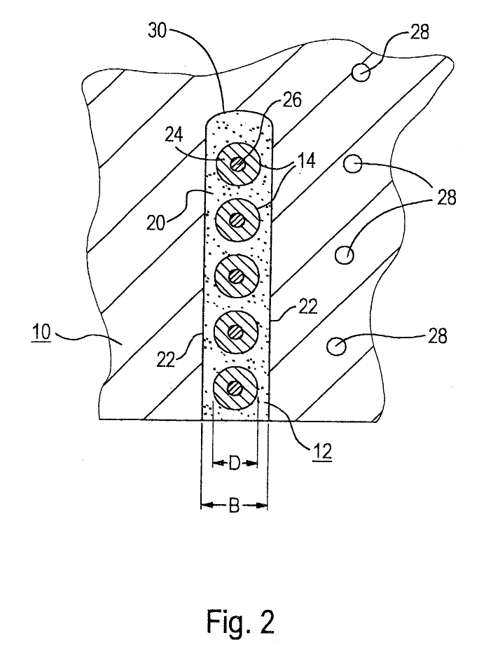

FIG. 2 a partially displayed channel in a main body of a stator, in which several high-voltage conductors are embedded by means of embedding material.

In accordance with the partial segment-like representation of a cross-section through generator 2 based on FIG. 1 designed as a high-voltage generator, generator 2 has a stator 4, which, upon formation of a gap 6, surrounds a rotor 8 in a circular ring. The stator 4 includes a main body 10, into which several channels 12 extend. Several high-voltage conductors 14, which are arranged next to each other in each channel 12 and form a row, with round cross-sections run in the individual channels 12. The channels 12 run in the axial or longitudinal direction of generator 2 and also extend in the radial direction into main body 10. They hereby extend beginning from the rotor interior side 16 of stator 4 into this up to approx. ⅔ of the stator height H.

The main body 10 is formed from individual tooth-like stator segments 18, which each have an approx. trapezoidal cross-sectional profile and extend in the longitudinal direction of generator 2. The individual stator segments 18 form the cylindrical main body 10.

As can be seen from the enlarged channel in FIG. 2, the high-voltage conductors 14 in the individual channels 12 are each surrounded by a powdered embedding material 20, which completely fills the hollow spaces remaining between high-voltage conductors 14 and channel 12. The embedding material 20 is preferably an aluminum-oxide powder or a mixture of an aluminum-oxide and an aluminum-nitride powder. Boron nitride or magnesium oxide can also be used as embedding material 20.

The powdered embedding material 20 enables the simple arrangement of the individual high-voltage conductors 14 in channel 12. The embedding material 20 thereby ensures that the individual conductors 14 are distanced from main body 10, i.e., from sidewalls 22 of channel 12, as well as from each other. Thus, in particular, an even distance is achieved between each other as well as to main body 10. This is particularly advantageous with respect to the most homogenous and evenly running electric and/or magnetic fields possible.

Moreover, due to the even distancing of the individual high-voltage conductors 14, the danger is low of damage based on elevated potential differences between the high-voltage conductors 14 with respect to each other and between them and main body 10. Potential differences that are too high can, under certain circumstances, lead to strokes that impair the insulating effect.

The powdered embedding material 20 thus improves the insulation of the individual high-voltage conductors 14 with respect to each other and to main body 10. The high-voltage conductors 14 already have, for insulating purposes, an insulating covering 24, which surrounds the actual cable core 26. The insulating covering 24 preferably consists of an insulating material, for example, plastic, as is used in conventional high-voltage conductors.

In addition to the insulating function, the embedding material 20 also creates good thermal coupling of the high-voltage conductors 14 to main body 10, which is cooled by means of a coolant that is fed through cooling channels 28. The coolant channels 28 are preferably arranged in main body 10 between channels 12 and run in the longitudinal direction of generator 2. A cool gas like air or hydrogen or also a cool liquid like oil can be used as a coolant. Hydrogen is normally used as the coolant for high-performance turbo generators due to its good cooling performance.

Since the individual high-voltage conductors 14 are firmly positioned in channel 12 by means of embedding material 20, it does not need to take over a holding or support function for the high-voltage conductors 14. Thus, it preferably has a simple design, i.e., as depicted, in particular with a rectangular cross-section. This enables the mainly smooth run of sidewalls 22, which is advantageous with respect to electric and/or magnetic properties. Channel 12 is preferably rounded on its front end 30, which lies in stator 4.

In accordance with FIG. 2, width B of channel 12 exceeds diameter D of high-voltage conductors 14. This guarantees that an additional electric insulating layer made of embedding material 20 is present between high-voltage conductors 14 and channel 12. With sufficient insulation of conductor core 26 over insulating covering 24, width B of channel 12 can be adjusted to diameter D so that the high-voltage conductors 14 lie next to sidewalls 22.

During the placement of high-voltage conductors 14 in channels 12, individual high-voltage conductors 14 and embedding material 20 are inserted in turn into channel 12 in order to achieve an even distancing of the individual high-voltage conductors with respect to each other. The powdered embedding material is preferably compressed by shaking. Based on the subdivision of main body 10 into individual stator segments 18, this type of procedure can be realized without problems.

1. Electric rotary machine (2), in particular, a high-voltage generator, with a stator (4), which has a main body (10) and a stator coil with a number of high-voltage conductors (14) running in the main body (10), characterized in that at least some of the high-voltage conductors (14) in main body (10) are embedded by means of an embedding material (20) and that the embedding material is powdered in form.

2. Machine (2) in accordance with claim 1 characterized in that the embedding material (20) has good thermoconductivity and/or good electric insulating properties.

3. Machine (2) in accordance with one of claims 1 or 2 characterized in that the embedding material (20) is a ceramic powder with good thermoconductivity and/or with good electric insulating properties.

4. Machine (2) in accordance with claim 3 characterized in that the ceramic powder contains at least one of the components aluminum oxide, aluminum nitride, boron nitride, or magnesium oxide.

5. Machine (2) in accordance with one of the previous claims characterized in that several of the high-voltage conductors (14) are arranged next to each other in the radial direction in a channel (12) running in the longitudinal direction through the main body (10).

6. Machine (2) in accordance with claim 6 characterized in that the channel (12) is bordered by even sidewalls (22) and, in particular, has a rectangular cross-sectional surface.
